(19) United States
(12) Patent Application Publication
(10) Pub. No.: US 2013/0231875 A1
(43) Pub. Date: Sep. 5, 2013

(54) APPARATUS, SYSTEMS AND METHODS FOR MONITORING FLUID FLOW IN BEVERAGE DISPENSING SYSTEMS

(71) Applicants: Richard Beckett, Cambridge (CA); Troy Schultz, Cambridge (CA); Evan Koslow, Kitchener (CA); David Reed, London (CA); Scott Lammers, Waterloo (CA)

(72) Inventors: Richard Beckett, Cambridge (CA); Troy Schultz, Cambridge (CA); Evan Koslow, Kitchener (CA); David Reed, London (CA); Scott Lammers, Waterloo (CA)

(21) Appl. No.: 13/388,833

(22) PCT Filed: Aug. 4, 2010
(86) PCT No.: PCT/CA10/01201

§ 371 Date: Apr. 10, 2013

Related U.S. Application Data
(60) Provisional application No. 61/231,301, filed on Aug. 4, 2009.
(60) Provisional application No. 61/334,399, filed on May 13, 2010.

(51) Int. Cl. G01F 1/05

(52) U.S. Cl. CPC G01F 1/05
USPC 702/45

(57) ABSTRACT

A monitoring system for a beverage dispensing system having at least one fluid conduit. The monitoring system includes at least one monitoring apparatus configured to be coupled to at least one fluid conduit, each monitoring apparatus having at least one sensor and being configured to determine when liquid is flowing through the conduit, at least one hub configured to receive information from the at least one monitoring apparatus about when liquid is flowing through the at least one conduit, and at least one processor configured to determine a volume of liquid flowing through the fluid conduit based on the information received from the at least one monitoring apparatus.

### RELATED APPLICATIONS

This application claims the benefit of U.S. Provisional Patent Application No. 61/231,301 entitled “APPARATUS, SYSTEMS AND METHODS FOR MONITORING FLUID FLOW IN BEVERAGE DISPENSING SYSTEMS” filed Aug. 4, 2009, the entire contents of which are incorporated herein by reference for all purposes. This application also claims the benefit of U.S. Provisional Patent Application No. 61/334,399 entitled “APPARATUS, SYSTEMS AND METHODS FOR MONITORING FLUID FLOW IN BEVERAGE DISPENSING SYSTEMS” filed May 13, 2010, the entire contents of which are incorporated herein by reference for all purposes.

### FIELD

The embodiments disclosed herein relate to monitoring fluid flow and in particular to invasive and non-invasive apparatus, systems and methods for monitoring of liquid flow in one or more conduits in beverage dispensing systems.

### INTRODUCTION

Beverage dispensing systems may be used to dispense a wide variety of finished and mixed food products, including coffee, tea, hot chocolate, carbonated beverages (e.g. soft drinks or soda pop), juices, soup, beer, and so on. Often the beverages include a mixture of one or more gases and liquids, and in some cases solids.

In some embodiments, the beverages may be provided to the system in a finished or “premixed” liquid state. In other embodiments, the beverages may be formed by mixing two or more components together within the beverage system (with at least one of the components being a liquid).

For example, a fountain drink dispensing system for dispensing soft drinks, iced tea, and the like may include a mixing and dispensing apparatus configured to receive one or more flavored sweetened syrups (which may be supplied as a “bag-in-a-box”), carbon dioxide gas (which may be supplied in compressed gas tanks), and water (which may be supplied though a water supply line). These fluids may be fed to the mixing and dispensing apparatus through one or more flexible conduits or hoses. The dispensing apparatus then mixes the received fluids according to particular specifications, and dispenses the desired beverage, for example by using a nozzle or a soda gun.

Such beverage dispensing systems tend to provide advantages over other delivery methods (e.g. supplying fully carbonated beverages in bottles or cans), including lower transportation costs (particularly where water and other components are mixed with syrup at the point of sale), increased convenience (as fluid supply reservoirs normally may contain much more product than a single bottle or can), and increased freshness.

However, it is often difficult to accurately determine the quantities of beverages being dispensed in these systems. This can be undesirable, for example, when trying to determine whether a proper amount of beverage was dispensed for a particular order (e.g. to combat theft, leaks or spillage), or when tracking inventory to determine when to order additional supplies.

Accordingly, the inventors have discovered a need for improved apparatus, systems and methods for monitoring fluid flow in beverage dispensing systems.

### BRIEF DESCRIPTION OF THE DRAWINGS

The drawings included herewith are for illustrating various examples of systems, methods and apparatus of the present specification and are not intended to limit the scope of what is taught in any way. In the drawings:

FIG. 1 is a perspective view of a non-invasive apparatus for monitoring fluid flow according to one embodiment;

FIG. 2 is a partial cross-sectional front view of the apparatus of FIG. 1;

FIG. 3 is a cross-sectional side view of the apparatus of FIG. 1;

FIG. 4 is a schematic diagram of a system for monitoring fluid flow in a beverage system according to another embodiment;

FIG. 5 is a partial cross-sectional front view of a non-invasive apparatus for monitoring fluid flow according to yet another embodiment;

FIG. 6 is a perspective view of an invasive apparatus for monitoring liquid flow in a conduit according to yet another embodiment;

FIG. 7 is another perspective view of the apparatus of FIG. 6;

FIG. 8 is a cross sectional view of the apparatus of FIG. 6; and

FIG. 9 is a schematic diagram of a system for monitoring fluid flow in a beverage system according to yet another embodiment.

### DETAILED DESCRIPTION

Generally, various apparatus, systems and methods for monitoring fluid flow in a beverage dispensing system are described herein.

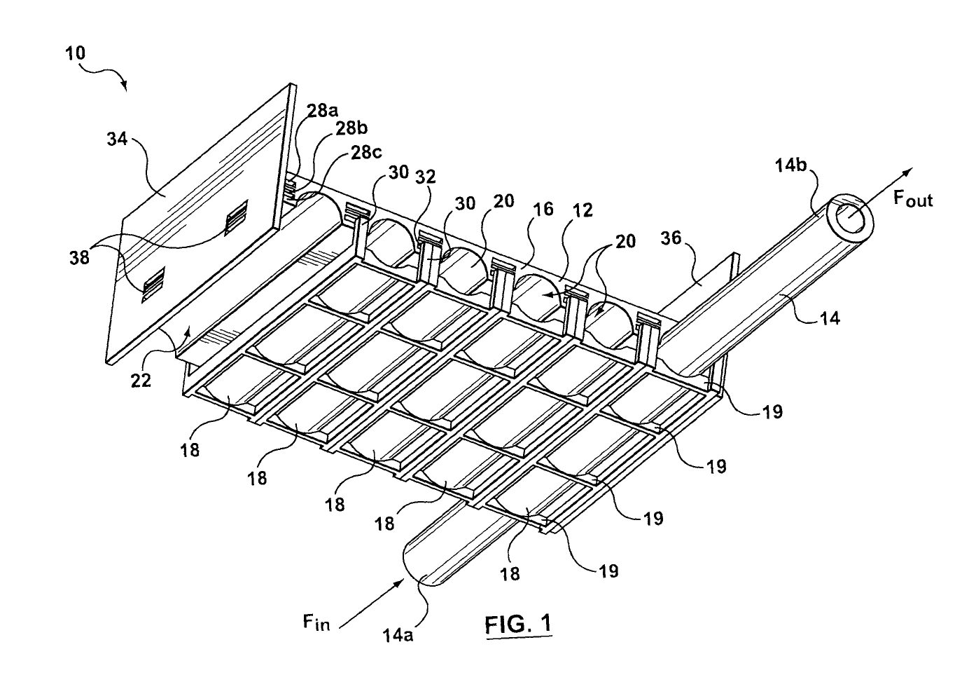

In some embodiments, the apparatus are non-invasive (e.g. external) and are configured so as not to come into direct contact with the various liquids (e.g. water) and gases (e.g. carbon dioxide) in a beverage dispensing system. For example, a mechanical actuator or sensor may be configured to contact the walls of a flexible fluid conduit, and in response to deflection of the walls determine when a liquid is flowing in the conduit. Examples of non-invasive apparatus are shown generally in FIGS. 1 to 3 and 5.

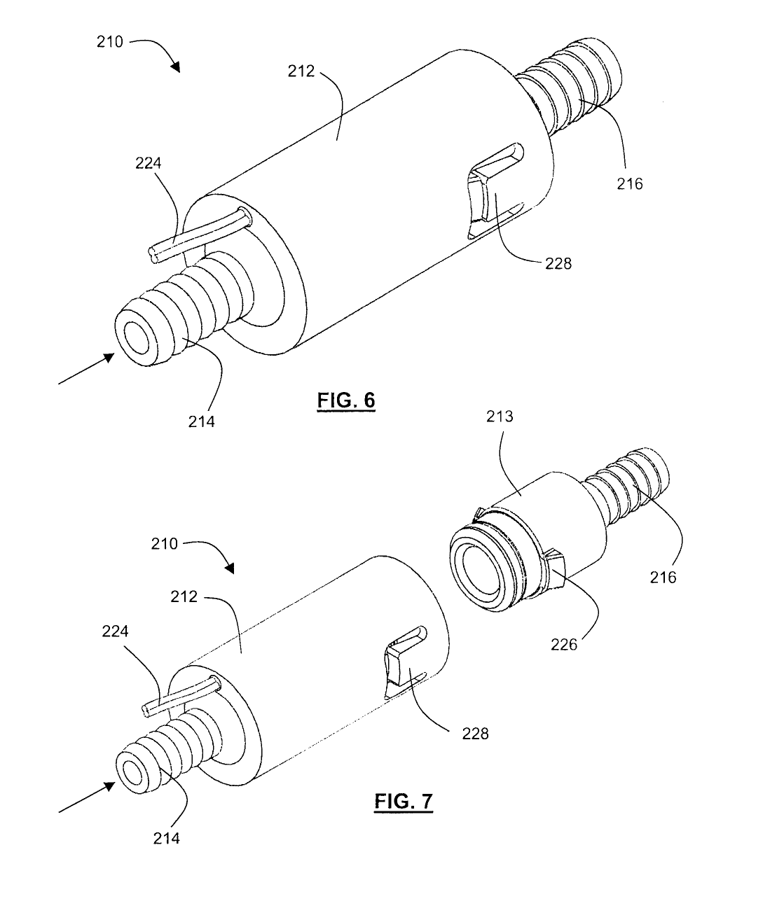

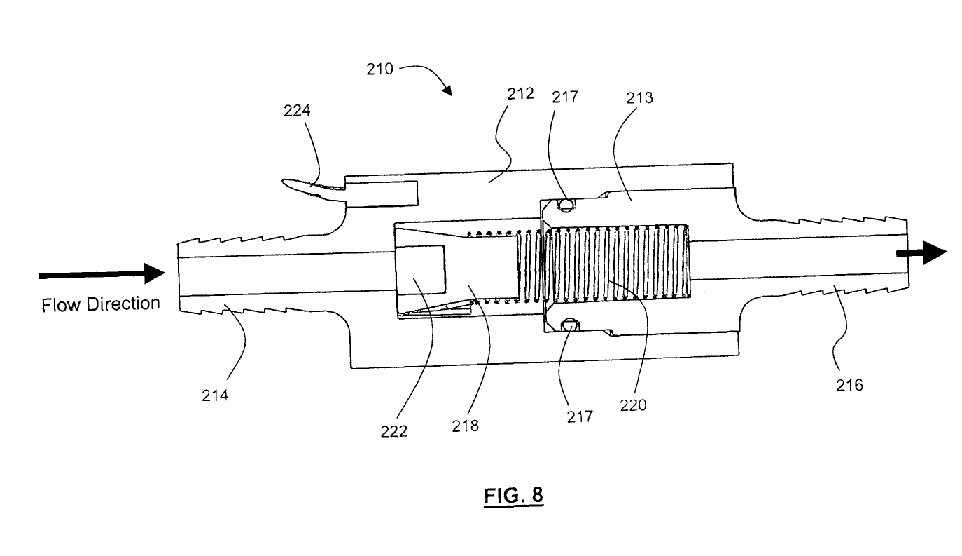

In other embodiments, the apparatus may be invasive (e.g. internal), in that the apparatus is configured to come into direct contact with one or more liquids (e.g. water) or gases (e.g. carbon dioxide) in a beverage dispensing system. For example, the apparatus could include mechanical actuator provided “in-line” with a fluid conduit and configured to move in response to contact with a liquid flowing through the apparatus to determine when the fluid is flowing in the conduit. An example of an invasive apparatus is shown generally in FIGS. 6 to 8.

Turning now to FIG. 1, illustrated therein is an apparatus 10 for monitoring fluid flow in a beverage dispensing system according to one non-invasive (e.g. external) embodiment. As shown, the non-invasive apparatus 10 may include a housing 12 sized and shaped to receive at least one fluid conduit 14 therein, wherein the at least one fluid conduit 14 has flexible walls.

The housing 12 may be provided in at least two separate pieces that can be coupled together, which may allow the housing 12 to be easily installed onto the conduits 14 (e.g. without disconnecting the conduits 14 from the mixing and dispensing apparatus or the fluid supply reservoir).

The housing 12 as shown includes an upper housing portion 16 and at least one lower housing portion 18. Accordingly, this monitoring apparatus 10 may be retrofitted to existing beverage dispensing systems without changing existing components of the system, cutting the conduits 14 or taking the beverage dispensing system offline.

When coupled together, the upper housing portion 16 and lower housing portions 18 cooperate so as to define at least one passageway 20 therebetween, each passageway 20 being sized and shaped so as to receive one of the conduits 14. In particular, the upper housing portion 16 includes at least one upper surface 22, while each lower housing portion 18 includes a lower surface 24.

The upper and lower surfaces 22, 24 are generally sized and shaped so as to securely engage with the conduits 14 to affix the housing 12 to the conduits 14. For example, the upper surface 22 and lower surface 24 may be sized and shaped so that each passageway 20 has a substantially circular cross section having a passageway diameter Dp. In some cases, the passageway diameter Dp may be selected so as to generally correspond to the outer conduit diameter Dc of the conduit 14. For example, the passageway diameter Dp may be selected so as to be substantially the same as, slightly larger than, or slightly smaller than, the conduit diameter Dc for the conduit 14.

In some embodiments, the conduit diameter Dc may be between 0.5 cm and 2.5 cm. In other embodiments, the conduit diameter Dc may be larger or smaller.

In some embodiments, since the walls of the conduits 14 are flexible, the passageway diameter Dp and the conduit diameter Dc need not substantially correspond but may have differing cross-sections, generally so long as the housing 12 may be securely affixed to the conduits 14.

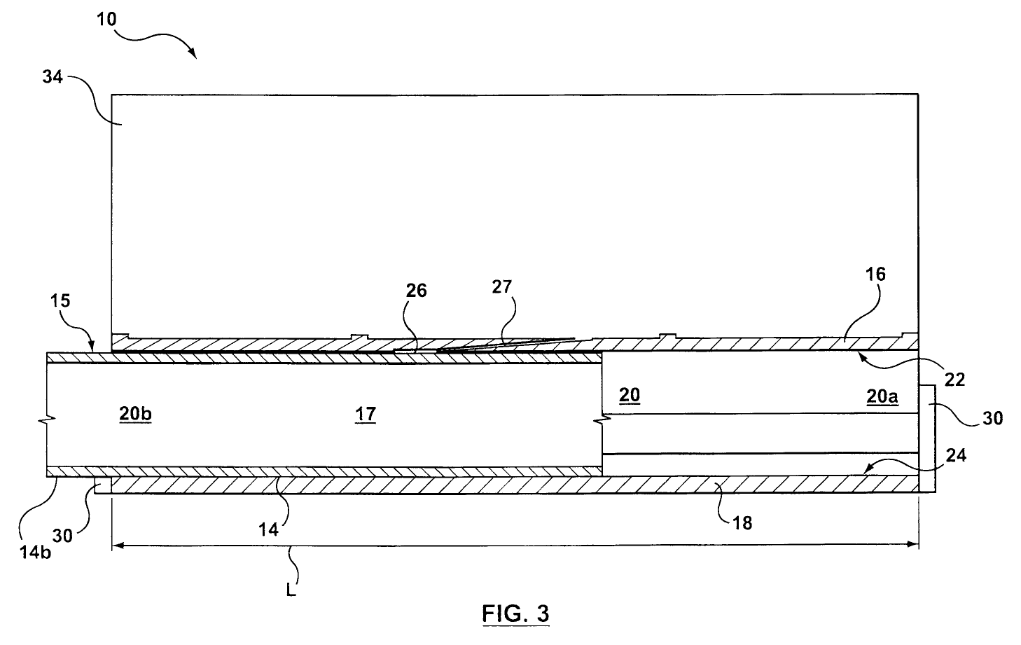

In some embodiments, the upper and lower surfaces 22, 24 may be sized and shaped such that each passageway 20 is generally cylindrical and has a passageway length L, as shown in FIG. 3. The passageway length L may be selected so engage a suitable length of each conduit 14 so as to secure the conduits 14 within the housing 12.

The length L may be generally proportional to the conduit diameter Dc and may be chosen so as to isolate a measurement region within the passageway 20 from external influences such as deflection (or flexion) of the conduits 14 or vibrations during use. In some embodiments the passageway length L may be between 2 cm and 10 cm.

Each apparatus 12 has at least one sensor 26, each of which may be provided in one of the passageways 20. Each sensor 26 may have at least one sensor element coupled thereto. Each sensor element may be a discrete device that provides an electrical signal based on a change due to a mechanical action resulting from a force, position, or deflection of a particular conduit 14 (e.g. due to a chance in conditions within that conduit 14, such as a pressure change).

Each sensor 26 may include a mechanical actuator to convey, convert, or amplify a given mechanical property (e.g. deflection of a wall of the conduit 14) in order to convert that mechanical property into an electrical signal.

In some examples, each sensor 26 may include elements to protect the sensor element (e.g. from contamination due to liquids etc.).

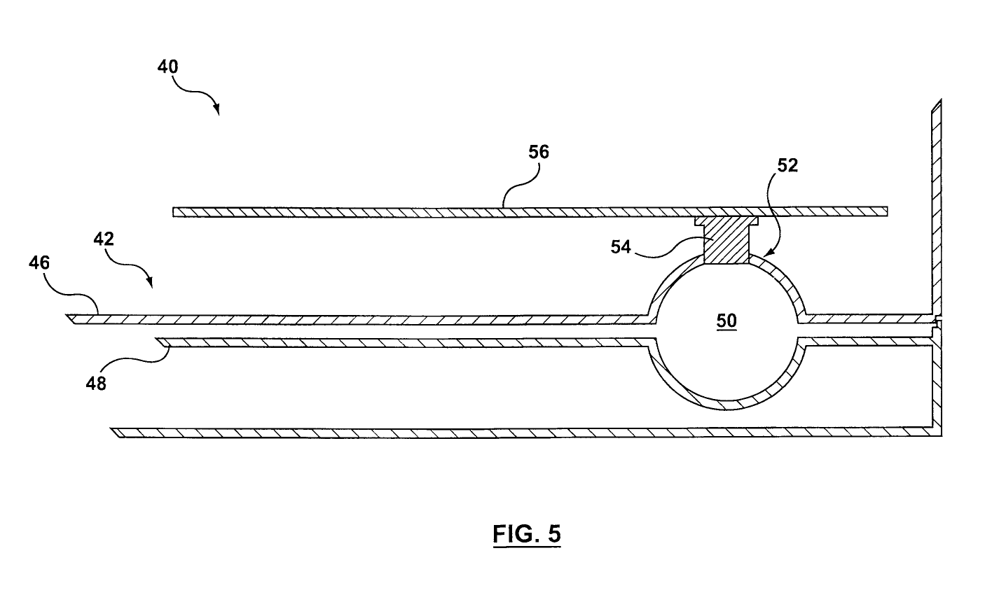

In some embodiments, the sensor 26 may be a direct strain gauge or force sensor. In other embodiments, the sensor 26 may include a plunger or other mechanical actuator placed in contact with the conduit 14 in such a manner as to conduct the forces to a strain gauge or force sensor, as will be described below with respect to FIG. 5.

Each sensor 26 is positioned to detect deflection of one of the walls of the flexible fluid conduits 14 when conditions in that flexible fluid conduit 14 are altered due to fluid flowing therethrough. For example, each sensor 26 may detect the deflection of one of the walls of the flexible fluid conduit 14 to determine when a valve (e.g. a snap-action valve) that is coupled to that particular conduit 14 is active (e.g. by detecting when the pressure in the conduit 14 changes, indicating whether the valve is ON or OFF).

Since the valves may operate with known fluid flow conditions (e.g. the flow rate when the valve is open may be known), by monitoring when the valve is active (e.g. ON or OFF), the flow rate of fluid within that conduit 14 can be determined.

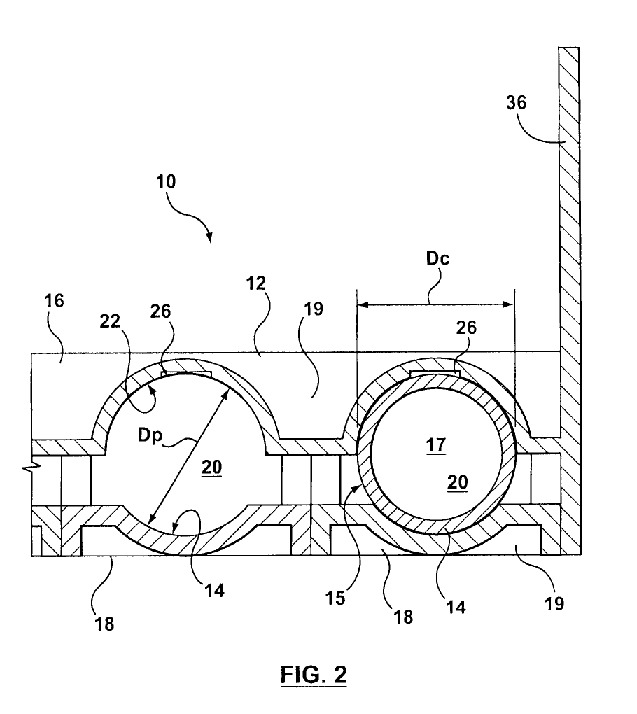

As shown in FIGS. 2 and 3, in some embodiments the sensors 26 may be provided in the upper surface 22 of the upper housing portion 16, generally between the inlet end 20a and the outlet end 20b of each passageway 20. In some embodiments, one or more sensors 26 may be provided in the lower surface 24 of the lower housing portions 18.

Each sensor 26 may be configured so as to engage with or contact the outer surface 15 of the conduit 14 received in the passageway 20 when the housing portions 16, 18 are coupled together. By engaging the outer surface 15, the sensor 26 can detect a mechanical property (e.g. the deflection of the walls of the conduit 14) when the conditions within that conduit 14 are altered.

For example, as shown in FIG. 1, incoming fluid F ₙ may pass through the housing 12, entering via the inlet end 14a of the conduit 14. As the fluid flows through the orifice 17 in the conduit 14 (e.g. when a valve connected to that conduit 14 is open), the walls of the conduit 14 will tend to deflect, and the sensor 26 can measure this deflection at the outer surface 15. The outgoing fluid Fₒᵤₜ then exits the housing 12 through the outlet end 14b of the conduit 14.

Conversely, when there is no fluid flow through the orifice 17 in the conduit 14 (e.g. when the valve is closed) the walls of the conduit 14 may experience little or no deflection.

The deflection of the outer surface 15 of the conduit 14 measured by the sensor 26 can be used to calculate the flow rate of the fluid passing through that conduit 14.

In some embodiments, each sensor 26 may be coupled to a sensor lead 27 for sending deflection data about the conduit 14 to a data processing unit, as will be described below.

Generally, the housing 12 may secure the conduits 14 (e.g. between the portions 16, 18) together in any suitable manner so that each sensor 26 is suitably positioned for monitoring the deflection of the outer surface 15 of each conduit 14.

As shown, in some embodiments the upper housing portion 16 may include one or more slots 28, and each lower housing portion 18 may include one or more fingers 30, each finger 30 having a tab 32 configured to engage one of the slots 28. The slots 28 and tabs 32 may cooperate so that sufficient clamping force can be provided between the housing portions 16, 18 to secure the conduits 14 within the housing 12 and to bias the sensors 26 against the outer surface 15 of each conduit 14.

As shown, in some embodiments, three slots 28a, 28b, and 28c may be vertically stacked such that the fingers 30 and tabs 32 may engage with different slots 28a, 28b, 28c depending on the size of the conduits 14. Accordingly, conduits 14 of different sizes may be used with the same monitoring apparatus 10.

In other embodiments, the upper and lower housing portions 16, 18 may be constructed as continuous members (e.g. integral members) that can be opened and closed instead of two physically separated portions. For example, the upper and lower housing portions 16, 18 may be integrally formed and coupled together along a flexible edge or pivot point (e.g. a living hinge) so that they can be flexed or otherwise opened to receive the conduits 14 therebetween. In such embodiments, the resiliency of the upper and lower housing portions 16, 18 and/or a spring mechanism may be used to bias the upper and lower housing portions 16, 18 together to apply a desired pressure against the conduits 14 to effect the operation of the sensors 26. In some embodiments, the rotation at the hinge may be used to measure the deflection of the conduits 14.

In some embodiments, the housing 12 may include mounting flanges for securely mounting the housing 12 (e.g. to a wall, a portion of a beverage dispensing system, etc.). For example, as shown in FIGS. 1 to 3, the upper housing portion 16 may include opposing end flanges 34, 36 that extend upwardly from the upper housing portion 16, generally away from the lower housing portions 18. The end flanges 34, 36 may include mounting slots 38 for engaging with one or more mounting members (not shown) and/or for securing a data processing module (not shown) to the housing 12.

In some embodiments, each conduit 14 may be a flexible plastic hose, and each sensor 26 may be a strain gauge or force sensor configured to measure mechanical properties, such as the deflection of the flexible plastic hose. In combination with some knowledge of the properties of the particular beverage dispensing system being monitored, this may yield a reasonably accurate indication of the volume of beverage being dispensed through each conduit 14.

Generally, any sensor which allows the conversion of a mechanical force into an electronic signal can be used. For example, with a suitable mechanical conversion of linear forces into rotary forces, rotary-type sensors type could be used.

In a particular beverage dispensing system, the pressure and density of the liquid beverage may be known (e.g. the pressure and density may be generally constant or may be measured), the size of the orifice 17 through which the beverage is dispensed is generally known (e.g. is normally constant), and other properties (e.g. the material properties of the conduit 14, etc.) may be known and/or determined as required. Thus, the flow rate through particular conduits 14 may be calculated using the apparatus 10.

As shown in FIGS. 1 to 3, the apparatus 10 may include a plurality of lower housing portions 18 that are each separate. However, in other embodiments, two or more lower housing portions 18 may be provided together as an assembly. For example, six lower housing portions 18 could be integrally formed and coupled to an upper housing portion 16 to define six passageways 20 therebetween.

In yet other embodiments, the housing 12 may not be provided as two separate pieces, but could instead be a single piece of material (e.g. a block of plastic) through which one or more conduits 14 may be fed.

In other embodiments, the housing 12 may be provided adjacent one or more of the conduits 14, and may not include passageways 20. Rather, in such embodiments the housing 12 may be simply configured to contact one or more sensors 26 against the one or more conduits 14 so that the deflection of the conduits 14 can be detected (when the conditions therein change, for example due to a pressure change).

In some embodiments, the housing portions 16, 18 may include one or more structural ribs 19 that may reinforce the housing 12 so as to resist deflection of the housing 12 during use. This may provide for more accurate readings, as the ribs 19 will tend to ensure that the deflections measured by the sensors 26 reflect the deflection of the conduits 14, and not the deflection of the housing 12 during use.

In some embodiments, the apparatus 10 may be provided with two or more passageways 20 to receive two or more conduits 14 therein for monitoring. Each passageway 20 may be provided in a linear array (as generally shown) or in any other suitable configuration. In other embodiments, the apparatus 10 may be provided with six passageways 20 so that six conduits 14 may be received therein for monitoring.

The upper housing portion 16 and lower housing portions 18 may be made of any suitable material, such as thermoplastics, thermosets, metals, ceramics, composites, and so on.

Turning now to FIG. 5, illustrated therein is an apparatus 40 for monitoring fluid flow in a beverage dispensing system according to another non-invasive embodiment. As shown, the non-invasive apparatus 40 generally includes a housing 42 sized and shaped to receive at least one flexible fluid conduit therein (e.g. conduit 14 as described above). The housing 42 includes an upper housing portion 46 and a lower housing portion 48 configured to be coupled together so as to define at least one passageway 50 therein.

Provided within each passageway 50 is a sensor 52. In this embodiment, the sensor 52 includes a mechanical actuator 54 (e.g. a small plunger) coupled to a sensor element 56. During use, the mechanical actuator 54 will transmit the mechanical movement of the conduit in the passageway 50 (e.g. flexion of the walls of the conduit) to the sensor element 56, and the sensor element 56 can convert the resulting forces into electrical signals.

In this manner, the sensor element 56 may be provided at a distance from the conduit. This tends to facilitate protecting the electronics, for example from physical damage as a result of impact or wear and also from fluid ingress. In particular, in some embodiments the mechanical actuator 54 can be sealed using an 0-ring or other sealing techniques so as to inhibit fluids from contacting the mechanical actuator 54 and/or the sensor element 56.

Turning now to FIGS. 6, 7 and 8, illustrated therein is a monitoring apparatus 210 or “flow switch” for monitoring liquid flow in a fluid conduit according to yet another embodiment. In this embodiment, the flow switch 210 is invasive in that the flow switch is designed to come into direct contact with a liquid in a beverage dispensing system.

As shown, the flow switch 210 may include a first body portion 212, an inlet end 214 and an outlet end 216. During use, the flow switch 210 is placed “in-line” with a fluid conduit so as to monitor fluid flow therethrough. For example, a fluid conduit may be cut, and the cut ends of the conduit coupled to the inlet end 214 and outlet end 216 so as to allow liquid to flow through the flow switch 210.

As the liquid enters the flow switch 210, it encounters a mechanical actuator, such as a plunger 218. The plunger 218 is normally biased towards the inlet end 214 (e.g. by using a compression spring 220) and may at least partially seal the flow switch 210, thus inhibiting fluid flow through the flow switch 210.

The pressure of the liquid entering the flow switch 210 acts against the plunger 218, and when the pressure exceeds a threshold value it tends to move the plunger 218 towards the outlet end 216, compressing the compression spring 220. This creates a fluid passageway around the plunger 218 that allows the liquid to flow past the plunger 218 and out through the outlet end 216.

In some embodiments, the compression spring 220 may be a light spring so that only a small amount of fluid pressure will be required before the plunger 218 will move.

The flow switch 210 is generally configured such that movement of the plunger 218 can be monitored and used to determine whether liquid is flowing through the conduit (e.g. an “ON” condition), or whether there is no liquid flowing through the conduit (e.g. an “OFF” condition).

As shown, in some embodiments a magnet 222 may be coupled to (e.g. embedded or molded within) the plunger 218. A reed switch 224 is then positioned to detect movement of the magnet 222 as the plunger 218 moves within the housing 212. In particular, the reed switch 224 may be positioned within the body portion 212 and configured to respond to the magnetic field of the magnet 222 as plunger 218 moves within the housing 212 between the closed position (e.g. no liquid flow) and the open position (e.g. liquid is flowing). Accordingly, the reed switch 224 can sense when liquid is flowing within the conduit.

As shown in FIG. 7, in some embodiments the monitoring apparatus 210 may be formed of two body portions, including the first body portion 212 and a second body portion 213. The second body portion 213 may be sized and shaped so it can be received within the first body portion 212. Making the body portions separable may allow the plunger 218 and spring 220 to be more easily positioned within the flow switch 210.

In some embodiments, an 0-ring 217 or other sealing device may be provided between the first body portion 212 and second body portion 213 to provide a seal therebetween and inhibit fluid leaks.

In this embodiment, since the flow switch 210 is provided “in-line” with a conduit, the conduit need not be flexible, but could in fact be rigid. For example, the conduits could be made of a rigid plastic (e.g. PVC), copper, etc.

In some embodiments, the flow switch 210 could be implemented in other ways, such as using a Hall-effect sensor, a contact sensor, a proximity sensor, capacitive sensors, and so on.

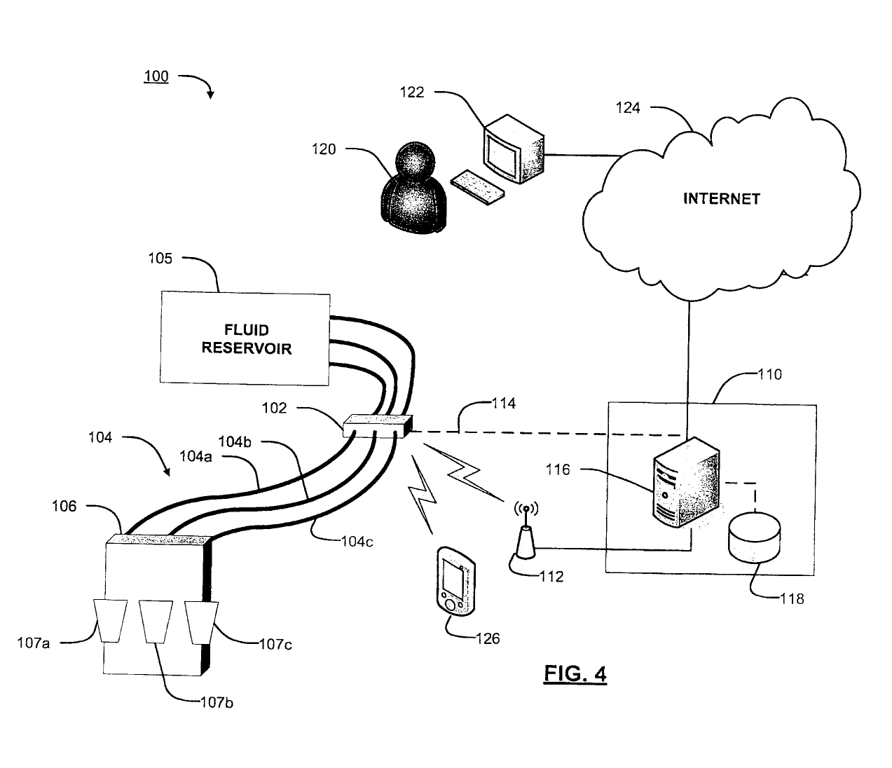

Turning now to FIG. 4, illustrated therein is a system 100 for monitoring fluid flow in beverage dispensing system according to another embodiment. The system 100 includes at least one monitoring apparatus 102 for monitoring fluid flow, which may be a non-invasive monitoring apparatus (e.g. apparatus 10 or 40) or an invasive monitoring apparatus (e.g. the flow switch 210) as generally described above. Each monitoring apparatus 102 is coupled to at least one fluid conduit 104 (which is flexible in the embodiments where a non-invasive monitoring apparatus is used). The system 100 may also include dispensing apparatus 106 (e.g. a fountain drink mixing and dispensing unit) used to dispense beverages (e.g. soft drinks).

When activated, the dispensing apparatus 106 will draw one or more fluids (e.g. flavored syrup) from one or more fluid supply reservoirs 105 via one or more conduits 104a, 104b, and 104c. The dispensing apparatus 106 may mix the fluids together and then dispense the desired beverage (e.g. using one or more nozzles 107a, 107b, 107c).

As each fluid flows through the conduits 104, sensors in each passageway of the monitoring apparatus 102 can monitor a mechanical property (e.g. the deflection of the walls or outer surfaces) for each conduit 104a, 104b, and 104c generally as described above. The sensors can then communicate this information to a data processing unit 110, for example using a wireless communication channel 112, or a wired communication channel 114.

The data processing unit 110 may store this deflection data in a memory 118 or other data storage device. The deflection data may then be used by a processor 116 to calculate the fluid flow rates and/or the duration of fluid flow for each a particular conduit 104a, 104b, 104c.

In some embodiments, this calculation may be done in real-time or substantially real-time (e.g. each time a beverage is dispensed through a conduit 104), at predetermined time intervals (e.g. once or twice a day) or upon receiving a request to calculate the flow rates (e.g. in response to a request from a remote user 120 using a computer 122 coupled to the data processing unit 110 via the Internet 124).

In some embodiments, each monitoring apparatus 102 may alternatively include a memory coupled thereto and which may store the flow rate data for subsequent access, for example using a hand-held computing device 126.

By calculating the fluid flow rates and/or the duration of fluid flow, the data processing unit 110 can be used to determine the quantity of a particular fluid flowing though each conduit. This may be helpful to determine whether an appropriate amount of beverage is being dispensed for each drink request (e.g. to combat theft and identify leaks in the beverage dispensing system).

The data processing unit 110 may also be configured to track the quantity of various supplies (e.g. flavored syrup) with minimal or no user interaction. In some embodiments, the data processing unit 110 can be configured to automatically order supplies as needed to ensure that the beverage dispensing system is properly stocked. For example, the data processing unit 110 may be configured to send a data message requesting additional supplies directly from a supplier over the Internet 124, or wirelessly through a cellular network (not shown), based on predetermined events (e.g. particular quantities of fluid remaining, etc.)

In some embodiments, the data processing unit 110 may be calibrated according to the properties of the particular beverage dispensing system to improve the accuracy of the readings. For example, a calibration process can be performed when the system 100 is installed. This calibration could include performing one or more “dispensing events” (e.g. dispensing different beverages that include different types of fluids) into a “calibration cup” having a known volume while monitoring each conduit 104a, 104b, 104c using the monitoring apparatus 102.

For example, the sensors in the monitoring apparatus 102 can monitor the deflection of each conduit 104a, 104b, 104c while a known volume (e.g. 1000 ml) is dispensed. This calibration may be performed one or more times to provide a number of data points for each conduit 104a, 104b, 104c. By recording the data provided by the sensors during each known “dispensing event”, the data processing unit 110 can be provided with a baseline that can be used to compare against subsequent dispensing cycles.

In some embodiments, a calibration may be performed at regular intervals after the system 100 has been installed to ensure that the system 100 remains accurate. For example, the system 100 could be recalibrated every three months, or every six months, or after a predetermined volume of liquid has been dispensed.

In some embodiments, the various components of the system 100 (e.g. the monitoring apparatus 102, and the data processing unit 110) can be designed and constructed in such a manner so as to provide good protection against fluid ingress. For example, the data processing unit 110 may be configured so as to have an ingress rating of IP-67 or better so as to inhibit liquid (e.g. flavored syrup) from damaging the components therein.

One of the advantages of using a non-invasive monitoring apparatus in the measurement system 100 is that there will be no required contact with any fluids, this making the fluids much less subject to contamination.

In some embodiments, the data processing unit 110 can be coupled directly to the housing (e.g. housing 12) of each monitoring apparatus 102 (e.g. via the flanges 34, 36).

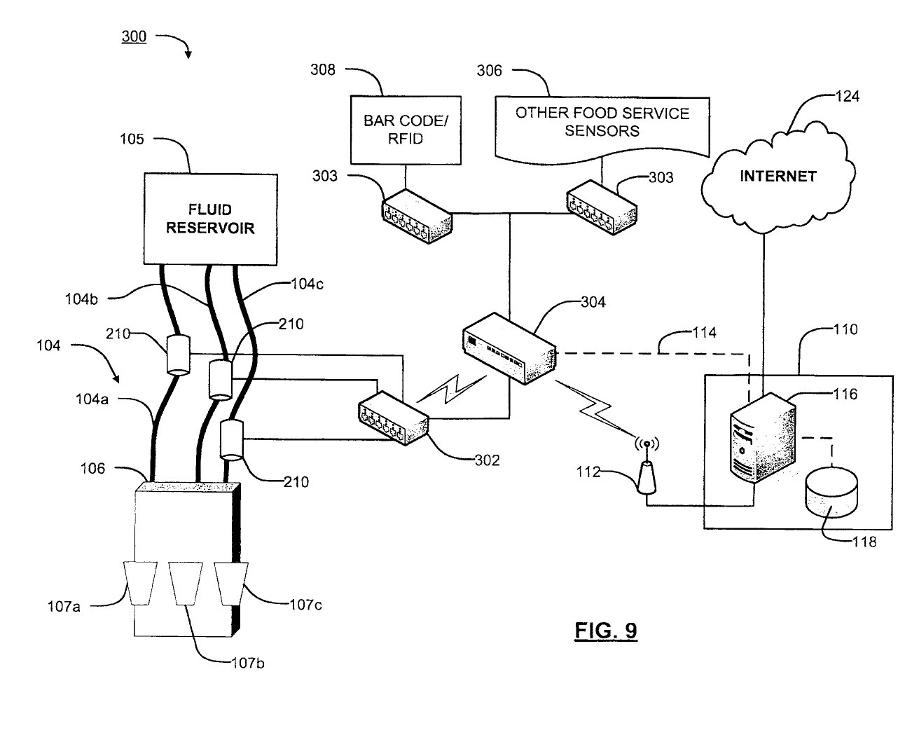

Turning now to FIG. 9, illustrated therein is a system 300 for monitoring liquid flow in beverage dispensing system according to another embodiment. The system 300 is generally similar to the system 100 as described above, and similar reference numerals have been used to indicate the same or similar elements.

Similar to system 100 as described above, the system 300 may include one or more invasive or non-invasive monitoring apparatus, such as the flow switch 210 for monitoring liquid flow between a fluid supply reservoir 105 and a dispensing apparatus 106.

Each flow switch 210 is coupled to one of the conduits (e.g. conduits 104a, 104b, and 104c) and monitors liquid flow therein as generally described above. During use, each monitoring apparatus 210 may communicate information about liquid flow through the corresponding conduit 104 to one or more hubs 302 (in some cases using a wired connection, a wireless connection, or both).

The hub 302 collects liquid flow data (e.g. ON/OFF information received from the flow switch 210), and in turn may send all or a portion of this data to a gateway 304 (e.g. using a wired connection, a wireless connection, or both). In some cases, the hub 302 may process the data before sending to the gateway 304 (e.g. the hub 302 may compress the data, extract and send only relevant portions of the data, and so on).

The gateway 304 in turn can then send information such as the volume of liquid flowing through the conduits 104a, 104b, 104c to the data processing unit 110.

For example, at least one of the hubs 302 and the gateway 304 may include at least one processor for calculating the volume of liquid flowing in a particular conduit 104 based on the ON/OFF data received from the monitoring apparatus 210 as well as other known properties for that conduit 104 (e.g. the characteristics of a pump used to pump liquid through the conduits 104, the pressure in the conduits 104, and so on).

In some embodiments, the gateway 304 may send other data (such as the ON/OFF data collected from the various monitoring apparatus 210) to the data processing unit 110 without performing additional processing thereon.

In some embodiments, the hub 302 may collect information about the conduits 104, the fluid supply 105, or both, from other sensors, such as temperature sensors, pressure sensors, and so on. The hub 302 in turn may send this data to the gateway 304.

In some embodiments, one or more other hubs 303 may be used to receive information from other sensors 306 about other aspects of one or more food service establishments. For example, other sensors 306 may send information to the other hubs 303 about status of inventory and supplies in a restaurant, status of equipment (e.g. whether equipment such as a refrigerator is properly running and at what temperature), and so on.

In some embodiments, one or more other hubs 303 may be coupled to other data collection devices 308, such as bar code readers, RFID readers, and so on. These data collection devices 308 may be used to track and measure supply levels (e.g. how many of a particular product are in an inventory storage location).

In some embodiments, the gateway 304 can send information collected from the sensors 306, data collection devices 308 and other hubs 303 to the data processing unit 110 for further processing. This may be useful for improved supply chain management, monitoring equipment reliability, and so on.

In some embodiments, the data and information collected using the various sensors as described herein could be used for various purposes. For example, in some cases the data could be used to monitor or discover trends in consumption patterns (e.g. how much and what type of beverages are being consumed at various geographic locations, at various times or day or week, etc.).

In some examples, the data could be combined with other data (which could be collected from other sources), which may allow other trends to be observed or determined. For example, other data could be used to monitor or discover consumption patterns in response to external factors, such as weather, social and economic conditions, performance of sports teams, and so on. In other cases, consumption patterns could be monitored or tracked in relation to internal factors about the persons consuming the beverages (e.g. information such as gender or age, cultural or historical backgrounds, and so on).

In some cases, the various data collected could be used in association with advertising programs, for example to track responses to particular advertising campaigns or to measure effectiveness of various promotional materials.

While the above description provides examples of one or more systems, methods and/or apparatuses, it will be appreciated that other methods and/or apparatuses may be within the scope of the present description as interpreted by one of skill in the art.

1. A monitoring system for a beverage dispensing system having at least one fluid conduit, the monitoring system comprising:
a) at least one monitoring apparatus configured to be coupled to at least one fluid conduit, each monitoring apparatus having at least one sensor and being configured to determine when liquid is flowing through the conduit;
b) at least one hub configured to receive information from the at least one monitoring apparatus about when liquid is flowing through the at least one conduit; and
c) at least one processor configured to determine a volume of liquid flowing through the fluid conduit based on the information received from the at least one monitoring apparatus.

2. The monitoring system of claim 1, wherein the at least one monitoring apparatus is non-invasive.

3. The monitoring system of claim 1, wherein the at least one monitoring apparatus is invasive.

4. The monitoring system of claim 1, wherein each monitoring apparatus is a flow switch provided in-line to the at least one fluid conduit

5. The monitoring system of claim 1, wherein the at least one processor is provided on a gateway, and the gateway is configured to send the volume of liquid flowing through each conduit to a data processing unit.

6. The monitoring system of claim 5, further comprising a memory in communication with the data processing unit and configured to store the volume data.

7. The monitoring system of claim 4, wherein each flow switch includes a body portion, a plunger providing within the body portion and configured to move in response to liquid moving through the body portion, and a sensor configured to monitor the movement of the plunger to determine when liquid is flowing through the body portion.

8. The monitoring system of claim 7, wherein the sensor in each flow switch comprises a magnet provided in the plunger and a reed switch configured to detect movement of the magnet within the body portion.

9. The monitoring system of claim 1, further comprising at least one other hub configured to receive information from at least one other food service sensor.

10. An apparatus for monitoring fluid flow in a beverage dispensing system having at least one flexible fluid conduit, the apparatus comprising at least one sensor, each sensor positioned to detect deflection of one of the flexible fluid conduits when conditions in that flexible fluid conduit are altered.

11. The apparatus of claim 10, further comprising a housing for securing each sensor in engagement with one of the flexible fluid conduits.

12. The apparatus of claim 11, wherein the housing defines at least one passageway, each passageway being sized and shaped to receive one of the flexible fluid conduits and to secure the at least one sensor in contact with an outer surface of that conduit.

13. The apparatus of claim 12, wherein the housing has at least two portions configured to be coupled together to define the at least one passageway.

14. The apparatus of claim 10, wherein the alteration of conditions in each flexible fluid conduit include a change in pressure.

15. The apparatus of claim 10, wherein each sensor is configured to detect deflection of one of the flexible fluid conduits to determine when a valve coupled to that flexible fluid conduit is active.

16. The apparatus of claim 10, wherein each sensor is further configured to communicate data about the deflection of the flexible fluid conduit to a data processor to calculate a quantity of fluid flow through that flexible fluid conduit.

17. The apparatus of claim 10, wherein each sensor includes a mechanical actuator configured to contact the flexible fluid conduit and a sensor element coupled to the mechanical actuator and disposed at a distance from the flexible fluid conduit.

18. The apparatus of claim 13, wherein the housing includes an upper housing portion having at least one upper housing surface, and at least one lower housing portion configured to be coupled to the upper housing portion and having at least one lower housing surface, the upper and lower surfaces having cross-sections corresponding to the outer surfaces of the at least one conduit.

19.-27. (canceled)

28. A monitoring system for a beverage dispensing system having at least one flexible fluid conduit, the monitoring system comprising:
(a) at least one monitoring unit configured to be coupled to the at least one flexible fluid conduit, each monitoring unit having at least one sensor; and
(b) a data processing unit;
(c) wherein each sensor is configured to detect deflection of one of the flexible fluid conduits when conditions in that flexible fluid conduit are altered and communicate data about the deflection of the flexible fluid conduit to the data processing unit.

29.-47. (canceled)

48. A method of monitoring fluid flow in a beverage dispensing system having at least one flexible fluid conduit, comprising:
(a) contacting at least one sensor with an outer surface of the at least one flexible fluid conduit;
(b) detecting deflection of one of the flexible fluid conduits when conditions in that flexible fluid conduit are altered; and
(c) based on the detected deflection, calculating the flow rate within that conduit.
